(19) United States
(12) Patent Application Publication
(10) Pub. No.: US 2022/0397091 A1
(43) Pub. Date: Dec. 15, 2022

(54) PIVOT ANGLE CONTROL OF BLADES OF A WIND TURBINE WITH HINGED BLADES

(71) Applicant: VESTAS WIND SYSTEMS A/S, Aarhus N. (DK)

(72) Inventors: Thomas S. Bjertrup NIELSEN, Randers SV (DK); Søren DALSGAARD, Hadsten (DK); Kim Hylling SØRENSEN, Aarhus C (DK)

(21) Appl. No.: 17/775,545

(22) PCT Filed: Nov. 5, 2020
(86) PCT No.: PCT/DK2020/050302

§ 371 Date: May 9, 2022

(30) Foreign Application Priority Data
Nov. 7, 2019 (DK) PA 2019 70685

(51) Int. Cl. F03D 7/02; F03D 1/06

(52) U.S. Cl. CPC F03D 7/0236; F03D 7/0224; F03D 7/024; F03D 1/0633; F05B 2240/302; F05B 2240/313; F05B 2270/331

(57) ABSTRACT

The invention is about a method for controlling a wind turbine with a variable rotor area. The wind turbine comprises a rotor with one or more rotor blades which are arranged hinged at an adjustable pivot angle, where the variable rotor area depends on the pivot angle, and where the pivot angle is adjustable dependent on a variable pivot force provided by a pivot actuator. The method comprises determination of a maximal pivot force based on the input operational parameter which relate to an actual load or a predicted load of the wind turbine, determining a desired pivot force based on a desired operational performance of the wind turbine, and determining a pivot force set-point to be applied to the pivot actuator based on the desired pivot force so that the pivot force set-point is equal to or below the maximal pivot force.

### FIELD OF THE INVENTION

The invention relates to methods for controlling a wind turbine having a rotor wherein blades are hinged to provide a variable rotor area, particularly to controlling the pivot angle of such hinged blades.

### BACKGROUND OF THE INVENTION

Wind turbines provided with wind turbine blades which are connected to a blade carrying structure via hinges allows a pivot angle defined between the wind turbine blades and the blade carrying structure to be varied. Thereby, the diameter of the wind turbine rotor and consequently the rotor area can be varied.

Accordingly, the rotor area can be increased at low wind speeds to increase and optimize power production and decreased at high wind speeds where the wind energy may be sufficient for production of a nominal wind turbine power so as to decrease the rotor thrust.

The flexibility of the wind turbine to adapt to different wind speeds implies that the same type of wind turbines with the same rotor type can be used at different locations with different wind conditions.

The possibility to use the same type of wind turbine under different wind conditions implies that some wind turbines may be exposed to higher wind induced loads that other wind turbines. Accordingly, there is a risk that a wind turbine may be exposed to high loads. One solution addressing this problem is to dimension the wind turbine components to worst case scenarios. However, this will increase costs. Accordingly, there is a need to improve wind turbines having variable rotor diameter to improve reliability and to reduce the risk of overloading the wind turbines when such wind turbines are used under varying wind conditions.

### SUMMARY

It is an object of the invention to improve turbines having variable rotor diameter such as improving the control of the pivot angle of the rotor blades. Particularly, it is an object to improve control of such wind turbines to improve reliability of operation and reducing the risk that the wind turbine is exposed to overloads.

In a first aspect of the invention there is provided a method for controlling a wind turbine with a variable rotor area, the wind turbine comprises a rotor with one or more rotor blades which are arranged hinged at an adjustable pivot angle, where the variable rotor area depends on the pivot angle, and where the pivot angle is adjustable dependent on a variable pivot force provided by a pivot actuator, the method comprises
obtaining an input operational parameter which relate to an actual load or a predicted load of the wind turbine,
determining a maximal pivot force based on the input operational para meter and,
determining a desired pivot force based on a desired operational performance of the wind turbine, and
determining a pivot force set-point to be applied to the pivot actuator based on the desired pivot force so that the pivot force set-point is equal to or below the maximal pivot force.

Advantageously, by determining a maximal pivot force based on wind turbine load data and constraining the desired pivot force according to the maximal pivot force, the same wind turbine operating under varying load conditions can be controlled with a limited pivot force which reduces the rotor area. In this way, the wind turbine can be controlled so that wind induced loads are kept sufficiently low.

The varying load conditions may be for a the same wind turbine at a specific location which operates under varying wind conditions over time, or the varying load conditions may be for different wind turbines, of the same type, operating at different locations which under different wind conditions.

The actual load or the predicted load of the wind turbine may be loads which are directly generated in response to the wind load, i.e. the rotor thrust. Alternatively or additionally, the load may not be directly related to the rotor thrust. For example, the wind turbine gear may show over average loads, e.g. due to a fault. The gear loads are not directly caused by wind loads, but a reduction of the rotor area and thereby the loading of the gear may be advantageous in order to avoid damaging of the gear.

According to an embodiment, the wind turbine comprises one or more of the pivot actuators arranged to generate the pivot force, and arranged so that the pivot angle is obtained dependent on a balance between at least the pivot force provided by the pivot actuator and a wind load force generated in response to a rotor thrust.

According to an embodiment, the blades are hinged at a location of a hinge between an outer blade tip and an inner blade tip where an extension between the inner blade tip and the hinge location defines an inner blade portion.

According to an embodiment, the pivot force is applied on a location of the inner blade portion, Advantageously, by applying a force a distance from the hinge location, the force needed to provide a required hinge torque is reduced proportionally with the distance.

According to an embodiment the maximum pivot force is determined dependent on a wind condition comprising one or more of a predicted or actual wind speed, a predicted or actual wind direction, a predicted or actual wind turbulence value and/or a predicted or actual wind shear value.

According to an embodiment, the input operational parameter is based on a wind condition comprising one or more of a predicted or actual wind speed, a predicted or actual wind direction, a predicted or actual wind turbulence value and a predicted or actual wind shear value, and/or is based on a predicted or actual wind turbine load.

According to an embodiment, the maximum pivot force is determined dependent on a wind condition comprising one or more of a predicted or actual wind speed, a predicted or actual wind direction, a predicted or actual wind turbulence value and/or a predicted or actual wind shear value.

Advantageously, by limiting the determined desired pivot force dependent on a wind condition, it is possible to ensure that loads due to the wind conditions does not exceed a given limit irrespectively of the pivot force determined by the pivot force controller, That is, when the pivot force controller attempts increasing power production by increasing the pivot force and rotor area, there could be situations where the resulting loads under the predicted or actual wind condition should be avoided.

According to an embodiment, the maximum pivot force is determined dependent on the predicted or actual wind speeds within a predetermined high thrust wind speed range, wherein the predetermined wind speed range is located below a nominal wind speed.

In other embodiments, the predetermined wind speed range may not be located below the nominal wind speed, but the predetermined wind speed range may include the nominal wind speed.

Due to the characteristics of the hinged rotor blades, maximal loads are normally generated in the high thrust wind speed range and, therefore, the maximum pivot force may only be determined for wind speeds in that range, or at least for that range.

According to an embodiment, the maximum pivot force is determined dependent on a value of the input operational parameter relating to an actual or predicted wind turbine load and dependent on a comparison of the input operational parameter relating to the actual or predicted load with a load threshold.

Advantageously, alternatively to or in addition to determining the the maximum pivot force is determined dependent on a wind condition, the maximum pivot force may be determined based on wind turbine loads so that further increases of the loads may be avoided by ensuring that the desired pivot force does not exceed the maximum pivot force. The wind turbine loads may be related to the wind induced loads or they may be due to other causes than wind effects, e.g. malfunctioning components which requires a limitation of the wind thrust.

According to an embodiment, the desired pivot force is determined dependent on a power reference and/or a wind speed reference for wind speeds above a nominal wind speed. The desired pivot force may be determined by various pivot force controllers and dependent on various input conditions. For example, the pivot force controller may be a type of a full load controller which aims at controlling the wind turbine to produce a given power for wind speeds above a nominal wind speed which is sufficient for producing a nominal power.

According to an embodiment, the desired pivot force is fixed for wind speeds, at least within a wind speed range, below a nominal wind speed. Advantageously, the pivot hinged blades may not need to be adjusted according to a controlled pivot force, e.g. due to the fact that the pivot angle is automatically varied due to the equilibrium of forces acting on the hinged blades.

A second aspect of the invention relates to a wind turbine control system arranged to perform the steps according to the first aspect.

A third aspect of the invention relates to a wind turbine comprising a rotor with a variable rotor area, where the rotor comprises one or more rotor blades which are arranged hinged at an adjustable pivot angle, where the variable rotor area depends on the pivot angle, and where the pivot angle is adjustable dependent on a variable pivot force provided by a pivot actuator, and the control system according to the second aspect.

A fourth aspect of the invention relates to a computer program product comprising software code adapted to control a wind power plant when executed on a data processing system, the computer program product being adapted to perform the method of the first aspect.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1 and 2 show a wind turbine comprising hinged rotor blades,

FIG. 3 shows a detailed view of a blade hinged to the arm of the blade carrying structure of the rotor,

FIG. 4 shows a control system for controlling the wind turbine, and

FIG. 5 shows an example of the thrust loading of a wind turbine as a function of wind speed.

### DESCRIPTION OF EMBODIMENTS

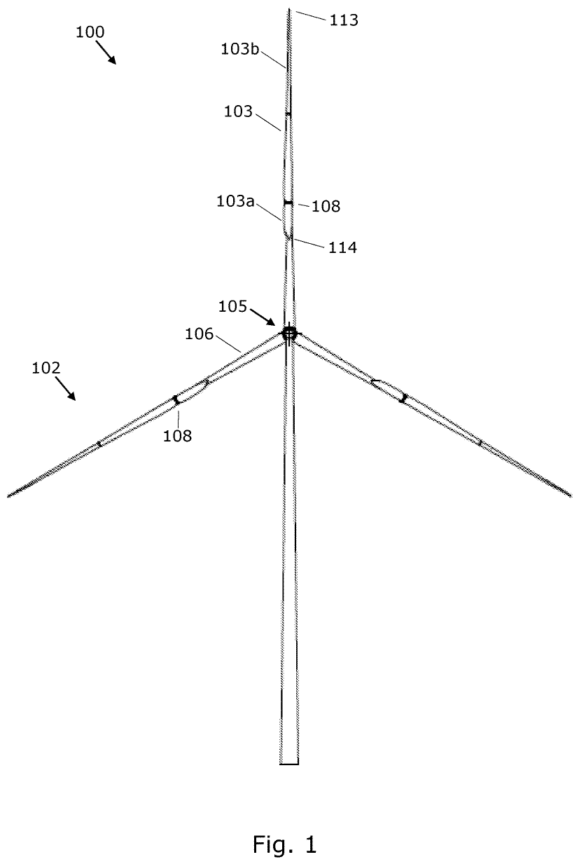

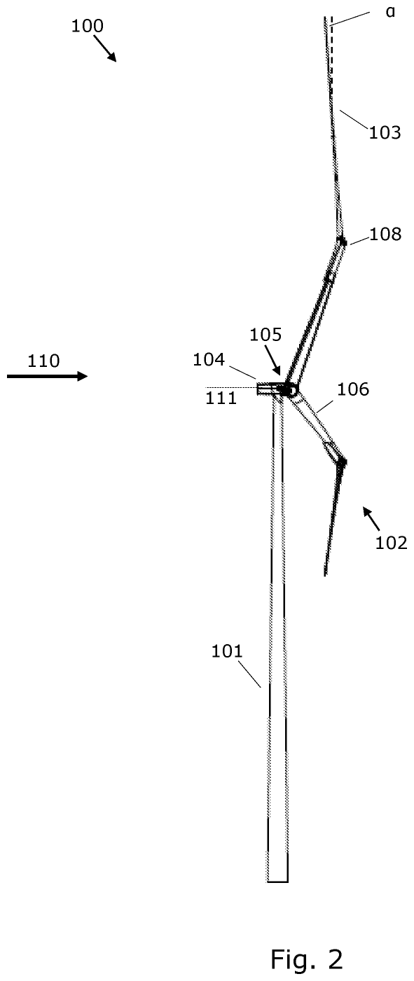

FIGS. 1 and 2 show an example of a wind turbine 100 (WTG) comprising a tower 101 and a rotor 102 with at least one rotor blade 103, such as three blades. FIG. 1 shows a front view with the blades facing the wind and FIG. 2 shows a side view seen perpendicular to the wind direction 110. The blades 103 are connected with the hub 105 which is arranged to rotate with the blades. The hub 105 comprises a blade carrying structure 106 which may be configured as a structure with arms, one per blade, extending radially relative to the main shaft axis of the hub to end-portions of the arms. The rotation axis of the main shaft axis is indicated with reference 111. The blades 103 are connected to the blade carrying structure 106, such as the arms thereof, via a hinge 108.

The rotor is connected to a nacelle 104 which is mounted on top of the tower 101 and is adapted to drive a generator situated inside the nacelle via a drive train comprising the main shaft axis 111. The rotor 102 is rotatable by action of the wind. The wind induced rotational energy of the rotor blades 103 is transferred via a shaft to the generator. Thus, the wind turbine 100 is capable of converting kinetic energy of the wind into mechanical energy by means of the rotor blades and, subsequently, into electric power by means of the generator. The generator is connected with a power converter, such as a power converter configured with a generator side converter and a line side converter where the generator side converter converts the generator AC power into DC power and the grid side converter converts the DC power into an AC power for injection into the power grid. The generator and the power converter is part of the power generating system of the wind turbine.

The wind turbine 100 is configured so that in a normal power producing operation, the rotor 102 is arranged on the lee side of the tower 101, i.e. as illustrated with the wind direction 110, the rotor is located to the right of the tower 101.

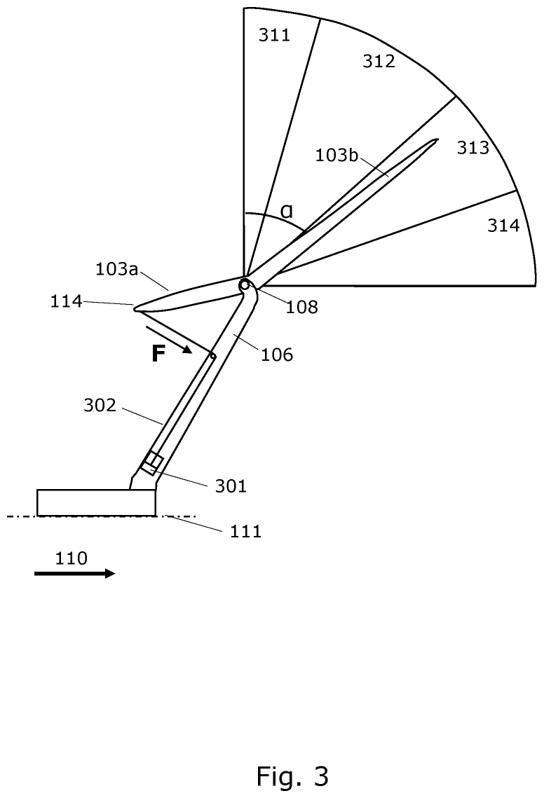

The blades may be hinged at a location between an outer blade tip 113 and an inner blade tip 114 so that the blade 103 comprises an inner blade portion 103a extending between the hinge location and the inner blade tip 114 and an outer blade portion 103b extending between the hinge location and the outer blade tip 113. During normal operation, the inner blade portion 103a extends from the hinge location towards the main shaft axis and the outer blades portion 103b extends outwards away from the main shaft axis, at least for a range of pivot angles. As is seen in FIG. 3, the inner blade portion 103a extends location towards the main shaft axis 111 for pivot angles from 0 to 80 degrees, assuming that the acute angle between the longitudinal extensions of the inner and outer blade portions is 10 degrees. At the 90 degrees pivot angle, the inner blade portion 103a points away from the main shaft axis 111.

Due to the hinged connection, the wind turbine blades 103 are able to perform pivot movement relative to the blade carrying structure 106. The pivot angle α is defined as the angle between the longitudinal axis of the outer blade portion 103b axis and plane normal to the main shaft axis. A pivot angle of 0 degrees means that the outer blade is normal to the main shaft axis and maximal rotor area occurs at this angle.

The rotor area is defined as the area within the outer blade tips 113 in a plane perpendicular to the main shaft axis. The actual swept area swept by the rotor blades is the area between the inner and outer blades tips 113, 114 in a plane perpendicular to the main shaft axis.

The rotor area varies as a function of pivot angle in such a manner that the rotor area is at a maximum when the pivot angle is at a minimum, and at a minimum when the pivot angle is at a maximum.

FIG. 3 shows a more detailed view of one arm of the blade carrying structure 106 with the blade 103 hinged to the arm.

The rotor 102 is designed to carry blade loads through the pivot hinge 108 and the pivot actuator 301 to the arm structure 106. This design allows the blades 103 to pivot around the hinge axis.

As illustrated, the pivot actuator 301 may be hydraulic actuator such as a hydraulic cylinder. For example as illustrated in FIG. 3, the position of the piston in the hydraulic cylinder is mechanically connected with the inner blade portion 103a, e.g. near the inner blade tip 114. The mechanical connection may comprise an elastic member 302 such as a spring. Alternatively, the elastic property of the pivot actuator may be achieved by controlling the position of the piston dependent on a measured piston force, e.g. so that the position is controlled according to Hookes law.

FIG. 3 illustrates the orientation of the outer blade portion 103a for different wind levels 311-314, from low wind levels 311 to high wind levels 314.

The pivot angle α can be adjusted by a variable pivot force F or variable pivot moment M provided by a pivot actuator 301. As will be clear from the description, adjusting the pivot angle α by use of the pivot actuator does not necessarily mean that the pivot angle α is controlled to approach a desired pivot angle. Adjusting the pivot force merely means that the actual pivot angle can be affected by the pivot force, but where the resulting pivot angle depends on a force equilibrium between the pivot actuator force generated by the pivot actuator 301, a wind load force generated due to the rotor thrust and elastic properties of the pivot actuator.

The rotor thrust is the load on the rotor 102 generated by the incoming wind and dependent on the aerodynamic properties of the blades 103.

Thus, in general the resulting pivot angle is obtained dependent on a balance between at least the generated pivot force and a wind load force generated in response to the wind load on the rotor 102. Other forces generated due to the elastic properties of the pivot actuator, centrifugal forces and/or aerodynamic forces are also included in the equilibrium and thereby affects the resulting pivot angle α.

The pivot actuator 301 may be configured to be able to generate a desired pivot force F or pivot moment M. For example, the pivot actuator may comprise a feed-back control system arranged to control the pivot actuator to generate the desired pivot force or pivot moment.

Herein, the pivot force F and pivot moment M are equivalent and the pivot actuator may be configured to provide a desired force or equivalently a desired moment. The relationship between the pivot force and the pivot moment is given by the distance between the hinge where the moment acts or is applied and a location on the inner blade portion 103a where the pivot force acts or is applied.

For example, with a given set-point for the actuator force, the force equilibrium implies that an increased wind speed and thereby increased wind thrust leads to an increase of the pivot angle α. This has the advantage that the rotor area may decrease in response to a wind gust.

Additionally, centrifugal forces and/or aerodynamic forces acting on the wind turbine blades 103 cause the wind turbine blades to pivot towards larger pivot angles α for increasing wind speeds. Thereby the ability of the wind turbine to extract energy from the wind decreases for increasing wind speeds, thereby causing a decrease in the rotational speed of the hub, which decreases the centrifugal and/or aerodynamic forces which are pushing the wind turbine blades towards smaller pivot angles. Accordingly, at any given wind speed, the wind turbine blades will find an equilibrium pivot angle which balances the various forces acting on the wind turbine blades. The higher the wind speed, the larger the equilibrium pivot angle will be.

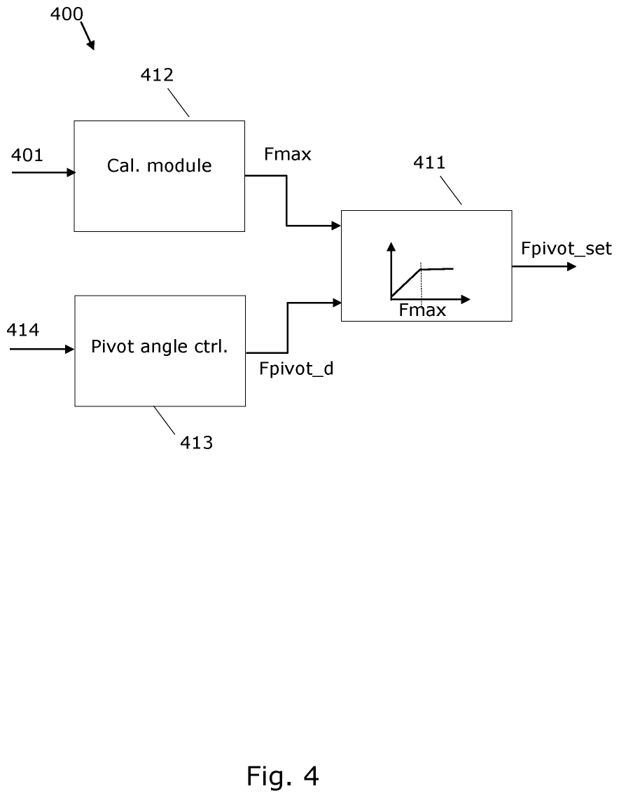

FIG. 4 shows a control system 400 for controlling the wind turbine 100 and for determining a set-point Fpivot_set for the pivot force to be applied to the pivot actuator. The set-point Fpivot_set is determined based on an initially determined desired pivot force Fpivot_d and a determined maximal pivot force Fmax, e.g. using a limit function 411 so that the pivot force set-point Fpivot_set is equal to or below the maximal pivot force Fmax. For example, the limit function 411 may compare the desired pivot force Fpivot_d with the maximal pivot force Fmax and limit the desired pivot force Fpivot_d to Fmax for forces above Fmax, whereas forces below Fmax are unchanged. The limit function 411 may be implemented as a software function in the control system 400 which determines the set-point Fpivot_set, Specifically; the limit function 411 may be comprised by the pivot angle controller 413. In general, the limit function 411 may be comprised by any relevant control system of the wind turbine 100. E.g. the limit function 411 could be implemented in a pivot actuator control system which is controls the pivot actuators.

The maximal pivot force Fmax prevents or limits the risk that wind induced WTG loads such as thrust loads exceeds maximal loads such as maximal thrust loads. Even though an applied pivot force does not necessarily provide a specific pivot angle, an increase in the pivot force generally leads to an increase in the pivot angle and therefore increased thrust loads and related WTG loads. For example, a power controller which aims at maintaining the power production at a nominal level may determine an increase of the desired pivot force Fpivot_d due to a decrease in the wind speed, Although the reduced wind speed reduces the thrust loads, other factors may have an effect on the WTG loads and therefore require a limit on the pivot force.

The maximal pivot force is determined based on one or more input operational parameters 401 which relate to an actual load or a predicted load of the wind turbine.

Examples of the input operational parameter 401 which relate to actual or predicted load of the wind turbine 100 includes predicted or actual wind conditions and predicted or actual wind turbine loads.

Thus, the input operational parameter may include values of predicted or actual wind turbine loads, or values relating to such loads. Predicted or actual wind conditions are examples of such vales which relate to wind turbine loads, for example wind speed relates to blade and tower loads via the rotor thrust generated by the wind.

Examples of actual and predicted wind conditions include wind speed, wind direction, wind turbulence and wind shear.

Equivalently, one or more wind conditions corresponding to the actual wind conditions may be predicted, e.g. the wind turbulence may be predicted based on wind speed and wind direction.

Based on the actual or predicted wind conditions, the expected thrust load or other wind turbine loads of the wind turbine can be determined, alternatively they have been measured or predicted beforehand. With a knowledge of the expected loads for a given wind condition or a set of wind conditions, the maximum pivot force can be set so that the rotor area and thereby the wind turbine load is adapted accordingly.

Examples of input operational parameters 401 which relate to predicted or actual wind turbine loads includes blade loads of the blades 102, tower loads of the tower 101, yaw loads and gear loads. Other load related examples of the input operational parameter 401 relate to acceleration or vibration levels of a wind turbine component such as blade accelerations, e.g. due to edgewise blade vibrations, and tower accelerations.

Such predicted or actual wind turbine loads may be caused by specific wind conditions or due to other reasons such as wear or unintended operation of a wind turbine component.

For example, main shaft loads may be due to wind turbulence, but could also be caused by blade icing or unintended operation of the gears. In any case, a too high main shaft load may be used to set a maximum pivot force in order to prevent further increases in the main shaft load.

The predicted or actual wind turbine loads may be compared with specified wind turbine load thresholds such as maximum load thresholds for the rotor blades 103, the tower 101 or other wind turbine components.

For example, the maximum pivot force may be determined dependent on a comparison of the operational parameter relating to an actual or predicted wind turbine load with a load threshold. For example, the maximum pivot force may be reduced for a value of the input operational parameter relating to the actual or predicted wind turbine load dependent on a comparison of the input operational parameter with a load threshold. In this example, the input operational parameter may comprise values of actual or predicted wind turbine loads which are directly comparable with the load threshold, or a value of the input operational parameter which relates to the actual or predicted wind turbine load may be compared with the load threshold or a related threshold.

In general, the wind turbine load threshold may be a maximal load specification of the wind turbine which relates to the wind turbine load threshold or a maximal load specification. For example, the maximal load specification may be a maximal pivot force specification or a minimal pivot angle specification which relate to a wind turbine load threshold or a maximum load specification. The maximal pivot force is then determined based on the input operational parameter and subject to a constraint defined by the maximal load specification.

Alternatively or additionally, the input operational parameter 401 could include data relating to variations of parameters of the wind turbine such as variations of the rotor speed and torque variations of the main shaft. Such variations may be due to variations in the wind conditions such as variations in wind speed, wind direction and wind shear, or due to wind turbulence.

For example, variations in the main shaft torque may be due to wind turbulence. In order to reduce loads due to wind turbulence, as indicated by the torque variations, the maximum pivot force may be set dependent on the measured main shaft torque variations.

The control system 400 comprises a calculation module 412 arranged to determine the maximal pivot force Fmax based on the input operational parameter 401.

The control system 400 further comprises a pivot angle controller 413 or a pivot angle control system 413 arranged to determine the desired pivot force Fpivot_d based on a desired operational performance of the wind turbine.

The desired operational performance of the wind turbine may be a desired power production, a desired loading of the wind turbine or other.

The pivot angle control system 413 can be configured in various ways and may depend on pivot angle input parameters 414 such as the wind speed, a wind speed reference, a power reference or other power value for the desired power production, a desired loading or other and combinations thereof. For example, the pivot angle control system 413 may be configured to determine the desired pivot force dependent on a power reference and/or a wind speed reference for wind speeds above a nominal wind speed. For example, the pivot force Fpivot_d can be determined based on the wind speed error determined as the difference between the wind speed reference and the measured wind speed where the wind speed reference is determined based on a power reference and where the power reference is further used to control the power converter.

For a certain range of wind speeds such as lower wind speeds e.g. below the nominal wind speed, the pivot force may be set, e.g. to a fixed pivot force or a maximum pivot force, in order to optimize or maximize the rotor area so as to optimize the power production.

The pivot angle control system 413 may be configured to determine the desired pivot force Fpivot_d independent of the maximal pivot force Fmax. Accordingly, the desired pivot force Fpivot_d may be determined so that it exceeds the maximal pivot force Fmax. For example, when the control system 413 is configured to determine the pivot force so as to produce a desired maximum power for wind speeds above a nominal wind speed, a sudden reduction of the wind speed will decrease the power production. In an attempt to maintain the power production, the pivot angle control system 413 may determine an increase of the pivot force Fpivot_d which could exceed the maximal pivot force Fmax.

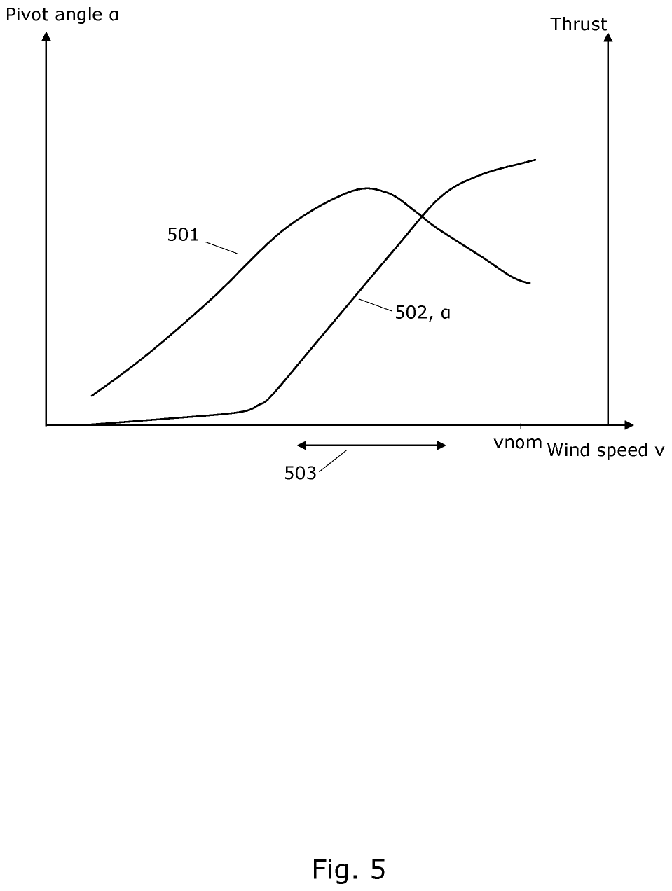

FIG. 5 shows an example of the pivot angle 502, a and the wind thrust 501 acting on the rotor as a function of wind speed v. The thrust exhibits a peak load within a high thrust wind speed range 503. The high thrust wind speed range 503 may be located below the nominal wind speed vnom, i.e. the wind speed where the wind turbine is specified to generate its nominal power. However, the nominal wind speed vnom is often located within the high thrust wind speed range 503 such as in a center part of high thrust wind speed range 503.

When the wind turbine is operated within the high thrust wind speed range 503, there is a risk that sudden increases in the thrust due to wind turbulence could lead to unacceptable peak loads. Accordingly, when the wind turbine is operated in the high thrust wind speed range 503, the maximum pivot force Fmax may be set to limit the risk of peak loads due to turbulence.

In order to compensate the peak thrust load within the predetermined high thrust wind speed range 503, the maximum pivot force may be reduced for predicted or measured wind speeds within the high thrust wind speed range. That is, the maximum pivot force is generally reduced for wind speeds within the high thrust wind speed range as compared with wind speeds, or at least a range of wind speeds, above the predetermined wind speed range, such as a range of wind speeds above the nominal wind speed.

Some wind turbine locations in a wind park may be more exposed to wind turbulence. Also some wind directions may have a higher occurrence or higher level of wind turbulence as compared with other wind directions. Accordingly, the maximal pivot force Fmax may be set dependent on wind turbine location and/or wind speed when the wind speed is within the high thrust wind speed range 503.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method for controlling a wind turbine with a variable rotor area, the wind turbine comprises a rotor with one or more rotor blades which are arranged hinged at an adjustable pivot angle, where the variable rotor area depends on the pivot angle, and where the pivot angle is adjustable dependent on a variable pivot force provided by a pivot actuator, the method comprises:
obtaining an input operational parameter which relate to an actual load or a predicted load of the wind turbine;
determining a maximal pivot force based on the input operational parameter;
determining a desired pivot force based on a desired operational performance of the wind turbine; and
determining a pivot force set-point to be applied to the pivot actuator based on the desired pivot force so that the pivot force set-point is equal to or below the maximal pivot force.

2. The method of claim 1, wherein the wind turbine comprises one or more of the pivot actuators arranged to generate the pivot force, and arranged so that the pivot angle is obtained dependent on a balance between at least the pivot force provided by the pivot actuator and a wind load force generated in response to a rotor thrust.

3. The method of claim 1, wherein the blades are hinged at a location of a hinge between an outer blade tip and an inner blade tip where an extension between the inner blade tip and the hinge location defines an inner blade portion.

4. The method of claim 3, wherein the pivot force is applied on a location of the inner blade portion.

5. The method of claim 1, wherein the input operational parameter is based on a wind condition comprising one or more of a predicted or actual wind speed, a predicted or actual wind direction, a predicted or actual wind turbulence value and a predicted or actual wind shear value, and/or is based on a predicted or actual wind turbine load.

6. The method of claim 1, wherein the maximum pivot force is determined dependent on a wind condition comprising one or more of a predicted or actual wind speed, a predicted or actual wind direction, a predicted or actual wind turbulence value and/or a predicted or actual wind shear value.

7. The method of claim 6, wherein the maximum pivot force is determined dependent on the predicted or actual wind speeds within a predetermined high thrust wind speed range.

8. The method of claim 7, wherein the predetermined high thrust wind speed range comprises a nominal wind speed.

9. The method of claim 6, wherein the maximum pivot force is determined dependent on the predicted or actual wind speeds within a predetermined high thrust wind speed range, wherein the predetermined wind speed range is located below a nominal wind speed.

10. The method of claim 1, wherein the maximum pivot force is determined dependent on a value of the input operational parameter relating to an actual or predicted wind turbine load and dependent on a comparison of the input operational parameter relating to the actual or predicted load with a load threshold.

11. The method of claim 1, wherein the desired pivot force is determined dependent on a power reference and/or a wind speed reference for wind speeds above a nominal wind speed.

12. The method of claim 1, wherein the desired pivot force is fixed for wind speeds, at least within a wind speed range, below a nominal wind speed.

13. (canceled)

14. (canceled)

15. A computer program product comprising software code which, when executed, is adapted to perform an operation controlling a wind turbine with a variable rotor area, the wind turbine comprising a rotor with one or more rotor blades which are hinged at an adjustable pivot angle, where the variable rotor area depends on the pivot angle, and where the pivot angle is adjustable dependent on a variable pivot force provided by a pivot actuator, the operation, comprising:
obtaining an input operational parameter which relate to an actual load or a predicted load of the wind turbine;
determining a maximal pivot force based on the input operational parameter;
determining a desired pivot force based on a desired operational performance of the wind turbine; and
determining a pivot force set-point to be applied to the pivot actuator based on the desired pivot force so that the pivot force set-point is equal to or below the maximal pivot force.

16. The computer program product of claim 15, wherein the wind turbine comprises one or more of the pivot actuators arranged to generate the pivot force, and arranged so that the pivot angle is obtained dependent on a balance between at least the pivot force provided by the pivot actuator and a wind load force generated in response to a rotor thrust.

17. The computer program product of claim 15, wherein the blades are hinged at a location of a hinge between an outer blade tip and an inner blade tip where an extension between the inner blade tip and the hinge location defines an inner blade portion.

18. A wind turbine, comprising:
a tower;
a nacelle disposed on the tower;
a rotor extending from the nacelle, the rotor having a variable rotor area;
one or more rotor blades disposed on the rotor and hinged at an adjustable pivot angle, where the variable rotor area depends on the pivot angle, and where the pivot angle is adjustable dependent on a variable pivot force provided by a pivot actuator; and
a controller configured to perform an operation, comprising:
obtaining an input operational parameter which relate to an actual load or a predicted load of the wind turbine;
determining a maximal pivot force based on the input operational parameter;
determining a desired pivot force based on a desired operational performance of the wind turbine; and
determining a pivot force set-point to be applied to the pivot actuator based on the desired pivot force so that the pivot force set-point is equal to or below the maximal pivot force.

19. The wind turbine of claim 18, wherein the wind turbine comprises one or more of the pivot actuators arranged to generate the pivot force, and arranged so that the pivot angle is obtained dependent on a balance between at least the pivot force provided by the pivot actuator and a wind load force generated in response to a rotor thrust.

20. The wind turbine of claim 18, wherein the blades are hinged at a location of a hinge between an outer blade tip and an inner blade tip where an extension between the inner blade tip and the hinge location defines an inner blade portion.
